(19) United States
(12) Patent Application Publication
(10) Pub. No.: US 2004/0181406 A1
(43) Pub. Date: Sep. 16, 2004

(54) Clamping and non linear quantization of extrinsic information in an iterative decoder

(76) Inventors: David Garrett,, Pyrmont (AU); Bing Xu, Gilbert, AZ (US)

Correspondence Address: Lucent Technologies Inc, Dockert Administrator, Room 3J 219, 101 Crawfords Corner Road, Holmdel, NJ, 07733-3030, US

(21) Appl. No.: 10/480,135

(22) PCT Filed: Aug. 2, 2002
(86) PCT No.: PCT/US02/24538

(30) Foreign Application Priority Data
Aug. 3, 2001 (AU) PR6802

(51) Int. Cl. G10L 15/00

(52) U.S. Cl. 704/242

(57) ABSTRACT

A method of iterative soft input-soft output decoding in which loglikelihood ratio and output extrinsic determination is performed upon a time slice of a trellis. A priori data input to the determination that are greater than or equal to a predetermined value are identified, and where such data is identified for any one time slice, that one time slice is removed from the determination. A quantizing function may be applied to the output extrinsic for each time slice. The quantizing function advantageously consists of a companding and flooring function. The quantized value is substituted for the output extrinsic value for that time slice.

### CROSS-REFERENCE TO RELATED APPLICATION

This application claims priority of Australian Provisional Application No. PR6802, which filed on Aug. 3, 2001.

### BACKGROUND OF THE INVENTION

I. Field of the Invention

The present invention relates generally to coding systems used in telecommunications and, more particularly to the reduction consumption in iterative decoding.

II. Description of the Related Art

Iterative decoding utilizes a feedback path to present recursive information derived from previous iterations to a current decoding iteration. The current decoding iteration utilizes the recursive information to refine a decoded symbol. Consequentially, the greater the number of iterations employed in the decoding process, the better the bit error rate performance realized. However, there are time and power costs associated with each iteration. Turbo decoding utilizes iterative decoding and random interleaving to achieve an error performance close to the Shannon limit. Consequently, iterative decoding is often employed in channel equalization and decoding for third generation (3G) mobile communications.

FIG. 1 shows a traditional configuration of a turbo decoder 100. Channel values 101 received by the turbo decoder 100 include systematic data, which represent the actual data being transmitted, and parity data, which represent a coded form of the data being transmitted. As seen in FIG. 1, a demultiplexer 103 receives the channel values 101 and demultiplexes the channel values 101 into systematic data 102, first parity data 104 corresponding to parity data of a first encoder module of a turbo encoder, and second parity data 105 corresponding to parity data of a second encoder module of the same turbo encoder. The demultiplexer 103 presents the first parity data 104 and the systematic data 102 to a first decoder module 106. The first decoder module 106 also receives first a priori data 117 from a deinterleaver 114. The first decoder module 106 performs decoding of the systematic data 102 and the first parity data 104 using the first a priori data 117 10 to produce first extrinsic data 107.

The first extrinsic data 107 represents the additional confidence information found in the first decoder module 106 based on systematic data 102, first parity data 104 and first a priori data 117 (the second decoder extrinsic information). However, the first decoder module 106 is a soft-output Is decoder, such that the extrinsic data 107 indicates a degree of confidence associated with each bit. For example, if the extrinsic data 107 is comprised of m bits, one bit is devoted to the sign of the decision, indicating whether the additional confidence was 0 (+) or 1 (−), and m−1 bits are devoted to the magnitude of the additional confidence value. Typically, the sign bit 0 is associated with a positive value and the sign bit 1 is associated with a negative value. Thus, a large positive number indicates that there is a high degree of additional confidence that the uncoded bit was a 0. Conversely, a small negative number would indicate that the decoder's additional information is for bit 1, but there is not much additional confidence associated with the value.

An interleaver 108 receives the first extrinsic data 107. The interleaver 108 permutes the first extrinsic data 107 with a known bit sequence and produces second a priori data 109, which is presented to a second decoder module 111.

The second decoder module 111 also receives the second parity data 105 from the demultiplexer 103. The second decoder module 111 operates in a manner corresponding to the first decoder module 106, but in a second time period, to decode the second a priori data 109 and the second parity data 105 to produce second extrinsic data 112 and decoded soft-outputs 113. A deinterleaver 114 receives the second extrinsic data 112 and performs deinterleaving, which is the inverse of the interleaving performed by the interleaver 108, using the same known bit sequence. The deinterleaver 114 produces the first a priori data 117, which is presented to the first decoder module 106, as described above.

The first and second extrinsic data 107, 112 (interleaved and deinterleaved, respectively, to form first and second a priori data 117, 109) passed between the first and second decoder modules 106, 111, provide a measure of a priori additional probability that bit decisions made by the first and second decoder modules 106, 111 are correct. The decoder module 106 or 111 active in the next time period uses the corresponding input a priori data, being the (de)interleaved extrinsic data, to produce a better estimate of the uncoded data. In order to generate the required bit probabilities, each of the first and second decoder modules 106, 111 utilizes soft-decision decoding algorithms.

A control unit 110 presents respective control signals 160, 161, 162, 163, 164 to the demultiplexer 103, first decoder module 106, second decoder module 111, interleaver 108 and deinterleaver 114 so as to afford a recursive mode of operation. The recursive nature of the turbo decoder 100 ensures that subsequent iterations will improve the probability that the decoded soft-outputs 113 accurately represent an originally transmitted information signal.

FIG. 2 shows a graph 200 of a typical distribution of extrinsic values after a number of iterations of a turbo decoding process. If a bit that is being decoded has an associated extrinsic value that is close to zero, there is a low degree of additional confidence from this decoder in respect of whether the value being decoded is a 0 or a 1. Accordingly, the extrinsic values associated with such bits being decoded typically oscillate about the vertical axis 210 until the degree of confidence in one or other of the decoded values, 0 or 1, grows in conjunction with the number of iterations of the decoding process.

Large positive extrinsic values 220 show an extremely high degree of confidence in additional information of the decoded bit being a 0. Similarly, large negative values 230 show a high degree of confidence in the additional information of the decoded bit being a 1. As can be seen from the graph 200, the majority of bits being decoded have associated extrinsic values that indicate a fair probability that the bit being decoded is either a 0, shown by the bell-like shape of the distribution on the right-hand side of the vertical axis, or a 1, shown by the bell-like shape of the distribution on the left-hand side of the vertical axis.

The memory requirements to store large extrinsic values are costly, as the interleaver 108 and deinterleaver 114 between the first and second decoder modules 106, 111 must store the entire block of the extrinsic information. For an 8-bit turbo decoding system using six iterations, the extrinsic value starts at zero, but may grow to a value of over 30,000 by the sixth iteration. Storing such numbers requires at least sixteen bits of precision to represent the full range of the extrinsic information. It is desirable to limit the amount of memory required for storing extrinsic values.

### SUMMARY OF THE INVENTION

It is an object of the present invention to substantially overcome, or at least ameliorate, one or more disadvantages of existing arrangements.

According to a first aspect of the invention, a method of iterative soft input-soft output decoding is provided in which loglikelihood ratio and output extrinsic determination is performed upon a time slice of a trellis. A priori data input to the determination that are greater than or equal to a predetermined value are identified, and where such data is identified for any one time slice, that one time slice is removed from the determination.

In an embodiment of the present invention, a quantizing function is applied to the output extrinsic for each time slice. If the absolute value of the output extrinsic value is less than 1, a quantized value is set to 0. Otherwise, the quantized value retains the sign of the output extrinsic value and the magnitude of the quantized value is equal to 2^{x}, where x is the largest integer from a range [0,y], such that 2^{x} is the largest integer less than or equal to the absolute value of the output extrinsic value. The quantized value is then substituted for the output extrinsic value for that time slice.

According to a second aspect of the invention, a method of iterative soft input-soft output decoding is provided that includes the step of identifying instances of input extrinsic data that exceed or are equal to a predetermined threshold. The predetermined threshold is then substituted is for each identified instance of input extrinsic data.

According to a third aspect of the invention there is provided a method of iterative soft input-soft output decoding. The method involves applying a companding and flooring process to each instance of extrinsic data. The companding and flooring process includes the step of determining the absolute value of the instance of the extrinsic data. If the absolute value of the instance of extrinsic data is less than 1, the method assigns a corresponding quantized value of 0 to the instance of extrinsic data. If the absolute value of the instance of extrinsic data is greater than or equal to 1, the method assigns a corresponding quantized value to the instance of the extrinsic data, wherein the corresponding quantized value retains the sign of the instance of extrinsic data. The magnitude of the corresponding quantized value is equal to 2^{x}, where x is the largest integer from a range [0,y] such that 2^{x} is the largest integer less than or equal to the absolute value of the instance of extrinsic data. The corresponding quantized value is then substituted for each instance of the extrinsic data for that one time slice.

According to a fourth aspect of the invention there is provided a decoder for use in an iterative soft input-soft output decoder arrangement. The decoder includes a comparator for comparing a priori data input to the decoder with a predetermined extrinsic value for each time slice of a trellis decoding operation. The comparator determines when the data input equals or exceeds the extrinsic value and, in response thereto, sets a flag corresponding to each said time slice. The decoder includes logic that is responsive to enablement of said flag for a corresponding time slice. The logic disables storage of metric values associated with that time slice and also disables a computation of a loglikelihood ratio corresponding to that time slice.

According to a fifth aspect of the invention there is provided a decoder for use in an iterative soft input-soft output decoder arrangement. The decoder includes an arrangement of butterfly processors for calculating a trellis using systematic data, parity data and a priori data. The butterfly processor arrangement includes an alpha memory in which alpha values determined during a forward recursion of the trellis are stored for subsequent loglikelihood determination. The decoder also includes a loglikelihood calculator for producing extrinsic values from the stored alpha values, beta values determined during a backward recursion of the trellis, branch metric values and the a priori data. A comparator receives the a priori data and a predetermined value, wherein the comparator compares each instance of the a priori data for a time slice against the predetermined threshold and if the instance of the a priori data is greater than or equal to the predetermined value, the comparator produces a flag enable signal corresponding to an entry in the alpha memory for the instance of the a priori data. The flag indicates that the corresponding alpha value does not need to be stored for the time slice and the predetermined threshold is presented to the loglikelihood calculator to be substituted for the corresponding alpha value for the production of the extrinsic values.

According to another aspect of the invention there is provided a computer program product including a computer readable medium having recorded thereon a computer program for implementing any one of the methods described above.

Other aspects of the invention are also disclosed.

### BRIEF DESCRIPTION OF THE DRAWINGS

The present invention will be better understood from reading the following description of non-limiting embodiments, with reference to the attached drawings, wherein below:

FIG. 1 is a schematic block diagram representation of a prior art arrangement of a turbo decoder;

FIG. 2 is a graph of a typical distribution of extrinsic values associated with a number of iterations of a turbo decoding process;

FIG. 3(a) shows the typical distribution of extrinsic values of FIG. 2 with the addition of clamped values;

FIG. 3(b) shows a companding and flooring function;

FIG. 4 graphically illustrates a prior art companding function;

FIG. 5 is a schematic block diagram representation of the elementary decoders of FIG. 1 in accordance with an arrangement of the present disclosure;

FIG. 6 illustrates an evaluation of a multi-state trellis; and

FIG. 7 is a schematic block diagram representation of the loglikelihood calculator of FIG. 5.

It should be emphasized that the drawings of the instant application are not to scale but are merely schematic representations, and thus are not intended to portray the specific dimensions of the invention, which may be determined by skilled artisans through examination of the disclosure herein

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

Whilst extrinsic values close to zero have a tendency to oscillate about the vertical axis 210, the present inventor has observed that once an extrinsic value attains a sufficiently large positive or negative value the extrinsic value increases monotonically in subsequent iterations, such that if the extrinsic value is positive, the extrinsic value will grow in a positive manner towards the point 220 with each further iteration of the decoding process. Similarly, if the extrinsic value is negative, the extrinsic value will grow towards the point 230 with each subsequent decoding iteration Since the growth of extrinsic values beyond a certain magnitude is thus predictable, once the extrinsic Is value attains a sufficiently large value to indicate whether the bit being decoded is probably a 1 or a 0, it is thus possible to clamp the extrinsic value and therefore realize benefits in the reduction of storage requirements in the interleaver 108 and the deinterleaver 114. Once the extrinsic value has been clamped, it is no longer necessary to calculate and store the subsequent extrinsic values. Thus, storing and reading the subsequent extrinsic values is obviated and power savings are realized.

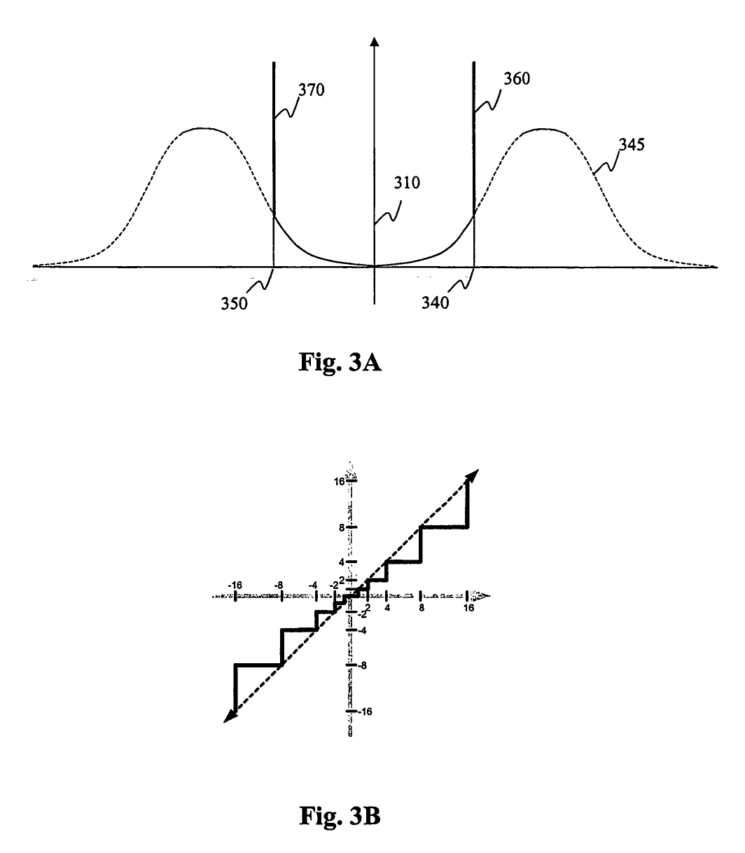

FIG. 3(a) shows extrinsic values 300 to which a positive clamp 340 and a negative clamp 350 have been applied. For positive extrinsic values, once the extrinsic value has attained the magnitude of the positive clamp 340 or is in excess of the positive clamp 340, further iterations of the decoding process utilize the clamp value, rather than a further computed extrinsic value. The dotted curve 345 shows a distribution of extrinsic values that would be in excess of the positive clamp 340. Applying the positive clamp 340 creates a large frequency value 360 at the positive clamp 340. A corresponding situation applies for the negative clamp 350, which creates a large frequency value 370. Consequently, it is possible to reduce the required memory size to store extrinsic values, as it is known that all extrinsic values will fall within the range defined by the positive clamp 340 and the negative clamp 350.

The present inventor has found that clamping the extrinsic information to a value only slightly larger than the input symbol values results in significant reductions in the memory requirement for the extrinsic memory, with no measurable loss in decoding performance. Further, once the extrinsic value information has reached the value of either one of the clamped values 340 and 350, the decoder 100 is no longer required to calculate new output extrinsic values for subsequent iterations, because having reached the degree of certainty measured by the clamped value, further iterations will only result in further degrees of certainty that the information being decoded is either a 1 or a 0. Thus, on subsequent iterations, having already reached the value of either one of the clamped values 340 and 350, the new extrinsic information would also be greater than the clamped value. Therefore, the decoder 100 can disable any computation related to computing the output extrinsic information for a bit being decoded that has an associated input extrinsic value that is already clamped.

High precision in the extrinsic values is desired for values dose to the vertical axis 310 and less precision is required for larger values closer to the clamping values.

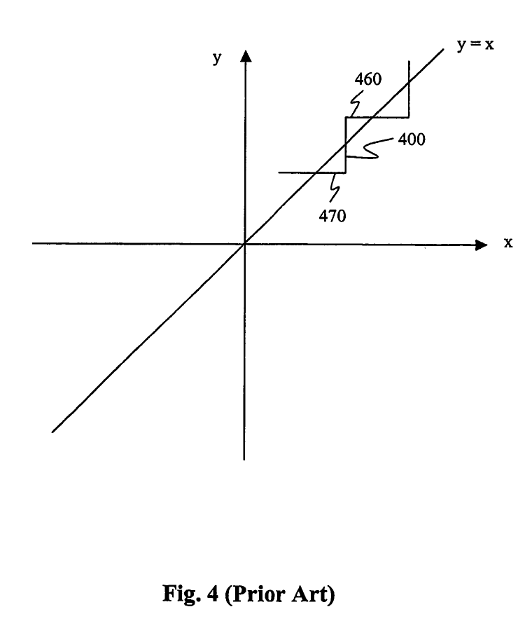

FIG. 4 shows a uniform step function 400 that oscillates about the line y=x. Adjusting extrinsic values to fit such a step function further reduces memory requirements. This is because in such an arrangement it is only necessary to store values corresponding to the step function 400, rather than store each possible discrete value. However, some extrinsic values will be overestimated, such as the point 460, whereas other extrinsic values will be underestimated, such as the point 470.

It is possible to round down the absolute value of the extrinsic information to a value equal to the closest power of two. For example, for a maximum value of 512, requantized extrinsic information will be an element of the set {0, 2^{x}), where x has a range of [0,9]. By utilizing such an encoding set, an extrinsic value may be requantized into a 5-bit signed magnitude number, with the lower four bits representing eleven possible values of the extrinsic information from 0 to 512.

FIG. 3(b) shows the companding and flooring function that may be applied to the clamped extrinsic values of FIG. 3(a). If the absolute value of the input extrinsic value is less than 1, the companded extrinsic value is set to 0. Otherwise, the companding and flooring function corresponds to finding the largest integer x from a range [0,9] such that 2^{x} is the largest integer less than or equal to the absolute value of the input extrinsic value. The companded extrinsic value retains the sign of the input extrinsic value. For an input extrinsic value of −312, for example, the largest integer x in the range [0,9] such that 2^{x} is less than or equal to |−312| is 8, as 2⁸=256 and 2⁹=512. Therefore, the corresponding companded value for an input extrinsic value of −312 would be −2⁸(=−256), as the sign of the input extrinsic value is retained.

Utilizing such an encoding scheme provides an extremely simple and yet fast encoding and decoding arrangement, further reducing the requirements of the extrinsic memory. As a floor function is applied to the absolute values of the extrinsic values, the extrinsic values are typically underestimated, but never overestimated, in contrast to the process of FIG. 4. The non-uniform scaling provided by the flooring function reduces the memory requirements for the extrinsic information. Furthermore, the application of such a companding function provides a dampening effect that results in faster and more controlled convergence of the decoding. The encoding scheme provides a high degree of precision for extrinsic data values close to zero and less precision for larger extrinsic values closer to the clamping values.

Once the extrinsic data has reached the clamped value, there is no reason to recalculate the values of the extrinsic data, because the new extrinsic data will also be the damped value. The extrinsic data output from either one of the decoder blocks 106 or 111 is computed by subtracting the a priori data received by the decoder block 106 or 111 from an output loglikelihood ratio (LLR) for each bit in the block. Unless the loglikelihood ratio information is needed outside of the turbo decoding block, the loglikelihood ratio and output extrinsic data do not need to be computed for the corresponding input extrinsic data that have been clamped.

A trellis diagram represents the possible state changes of a convolutional encoder over time. Each state in the trellis is connected, via two associated branch metrics, to two separate states in the trellis in the next time period. When decoding received symbols, decoding algorithms typically traverse the trellis in a forward direction to determine the probabilities of the individual states and the associated branch metrics.

The logMAP algorithm differs from other decoding algorithms, such as the Viterbi algorithm, by performing both a forward and a backward recursion over a trellis. The LogMAP algorithm can be partitioned to provide a Windowed LogMAP arrangement where the blocks are divided into smaller alpha and beta recursions. Alpha values, representing the probabilities of each state in the trellis, are determined in the forward recursion. Beta values, representing the probabilities of each state in the reverse direction, are determined during the backwards recursion.

A LogMAP turbo decoder can apply the clamping process described above to further reduce power through two mechanisms:

If the extrinsic is clamped, calculate the forward alpha trellis computation, but no longer store the alpha results for that particular bit; and

Compute the backward recursion for beta, and whenever the corresponding extrinsic is damped, disable computation of loglikelihood ratios and extrinsic values.

Although the local path metric memory only has a depth equal to the window size, it has a wide input word in order to store alpha values for all states of the trellis simultaneously. Thus, clamping is effective in reducing the power associated with write accesses to alpha memory, because the alpha values are not stored when the associated input extrinsic is clamped. The LLR calculation uses two sets of logsum trees to compute the log of probability of a zero and the log of probability of a 1. Disabling the logsum trees results in further savings in the logic power. Table 1 shows the percentage of extrinsic values that were clamped in the turbo system (rate 1/3, block size 1700, UMTS interleaver, with extrinsic companding) on a per iteration basis. In the later iterations, most of the path metric memory writes and the LLR computations can be disabled.

TABLE 1
Percentage of Clamped Extrinsics

| | Signal to noise ratio | | | | |
|---|---|---|---|---|---|
| Iterations | 0.0 dB | 0.5 dB | 1.0 dB | 1.5 dB | 2.0 dB |
| 1 | 0.000 | 0.000 | 0.000 | 0.000 | 0.002 |
| 2 | 0.000 | 0.002 | 0.008 | 0.073 | 0.318 |
| 3 | 0.000 | 0.011 | 0.089 | 0.552 | 0.880 |
| 4 | 0.001 | 0.078 | 0.370 | 0.879 | 0.963 |
| 5 | 0.004 | 0.234 | 0.631 | 0.944 | 0.970 |
| 6 | 0.005 | 0.486 | 0.775 | 0.953 | 0.970 |

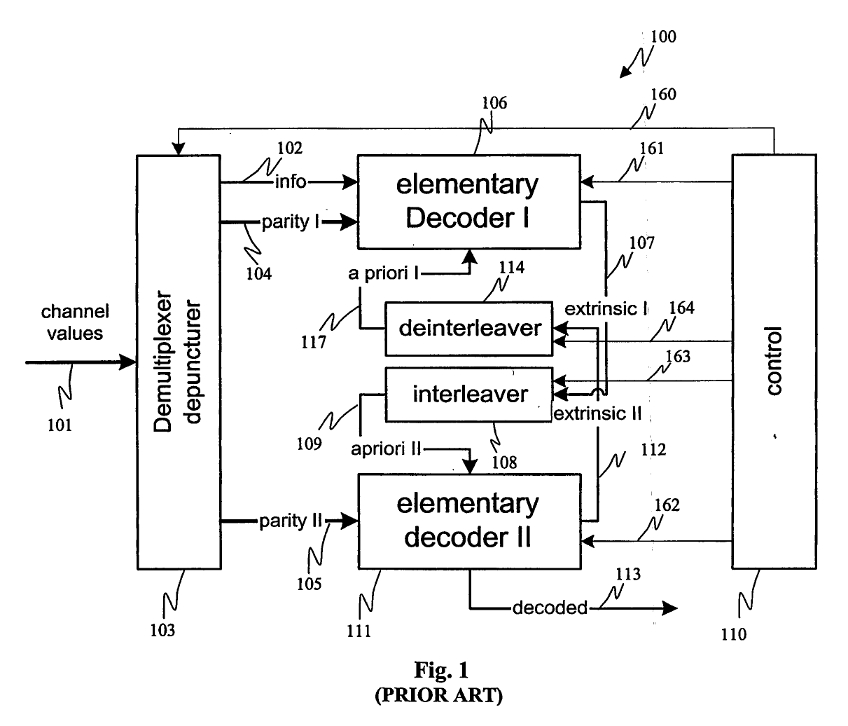

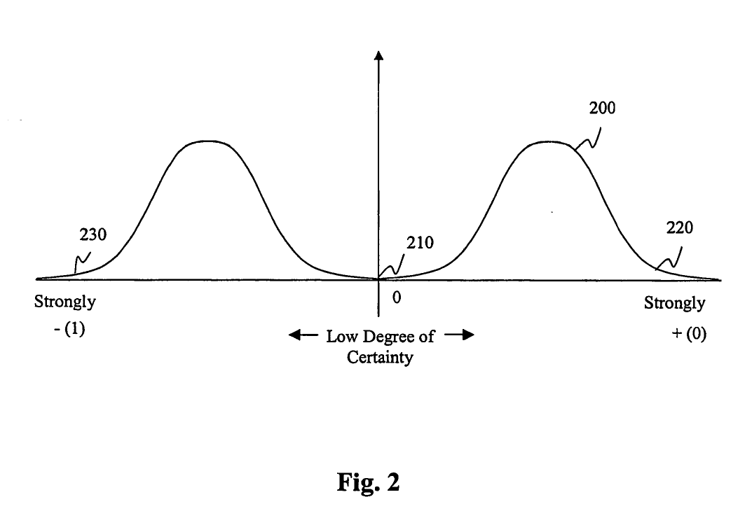

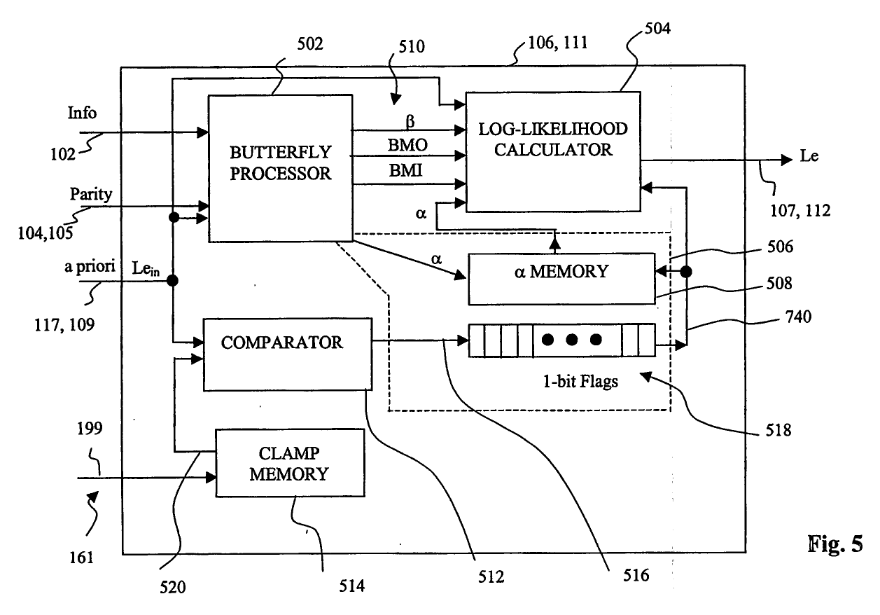

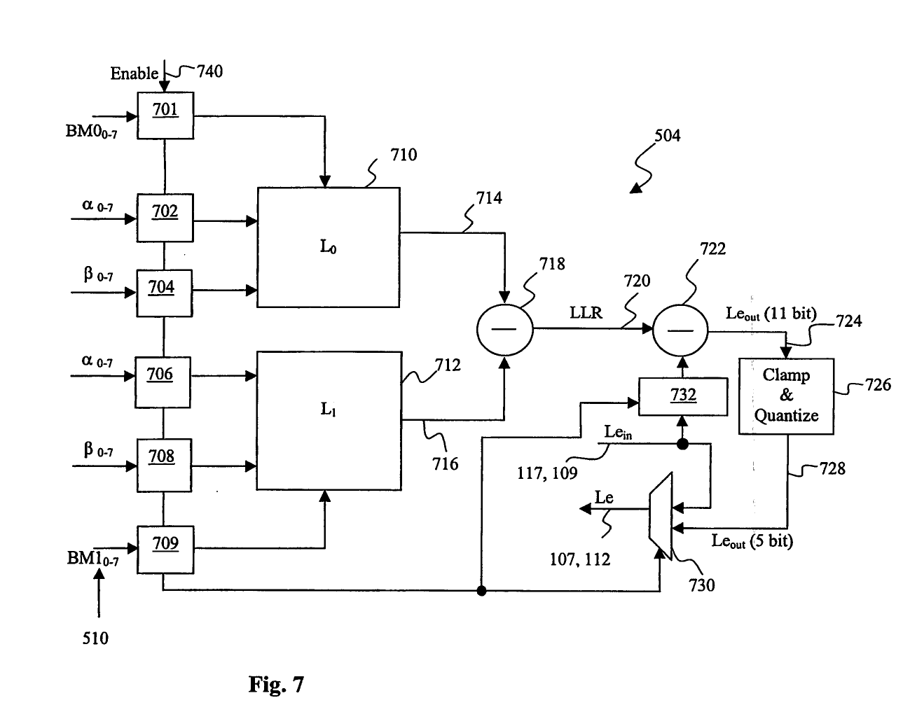

The above-described refined iteration process may be implemented using the arrangements show in FIGS. 5 and 7. FIG. 5 shows an expanded arrangement of the elementary decoders 106 and 111, which receive parity, inputs 104 and 105 together with a priori information 117 and 109. The information input 102 seen in FIG. 1, whilst only used by the elementary decoder 106, is in practice carried to the elementary decoder 111 by virtue of the a priori input 109. The information 102, parity 104,105 and a priori 117,109 inputs are provided to an arrangement of butterfly processors 502 which operate to calculate a trellis for turbo decoding. As illustrated by a section 506 in FIG. 5, the butterfly processors include an α memory 508 in which α values obtained from a forward calculation of the trellis are stored for subsequent loglikelihood determination. The butterfly processors 502, when performing a reverse calculation of the trellis, determine β values. The β values and stored α values from α memory 508, together with branch metric values BM0, BM1 and the a priori data 117, 109, collectively indicated at 510 in FIG. 5, are passed to a loglikelihood calculator 504 for calculation and output of the extrinsic value (Le) 107,112.

So as to implement the clamping function described above, the decoder 106, 111 also includes a comparator 512, which is presented with the a priori data 117, 109 together with a clamp value 520. The clamp value 520 is set in memory 514 at the maximum value the extrinsic can reach (damped values 340 and 350). The clamp value is advantageously determined according to the following equation:

Le_{clamp}>>max (y+p)

where y is the data and p is parity. In practice, if max (y+p) is 128, then a clamp value of 512 may be used. This is chosen so that the clamp value clearly dominates the range of possible values calculable from the input data. The clamp values may be loaded to the memory 514 by an input 199 derived from the control input 161.

The purpose of the comparator 512 is to provide flag values 516 which are retained in a memory 518 associated with the α memory 508. For each entry in the α memory 508 there is a corresponding flag in the memory 518. The purpose of this flag is that when the a priori data 117,109 is greater than or equal to the clamp 520 the corresponding flag in the memory 518 is set to indicate that the corresponding entry in the α memory 508 need not be stored and is void. The state of each flag in the memory 518 for a time instance is presented to each of the α memory 508 and the loglikelihood calculator 504 by an enable signal 740.

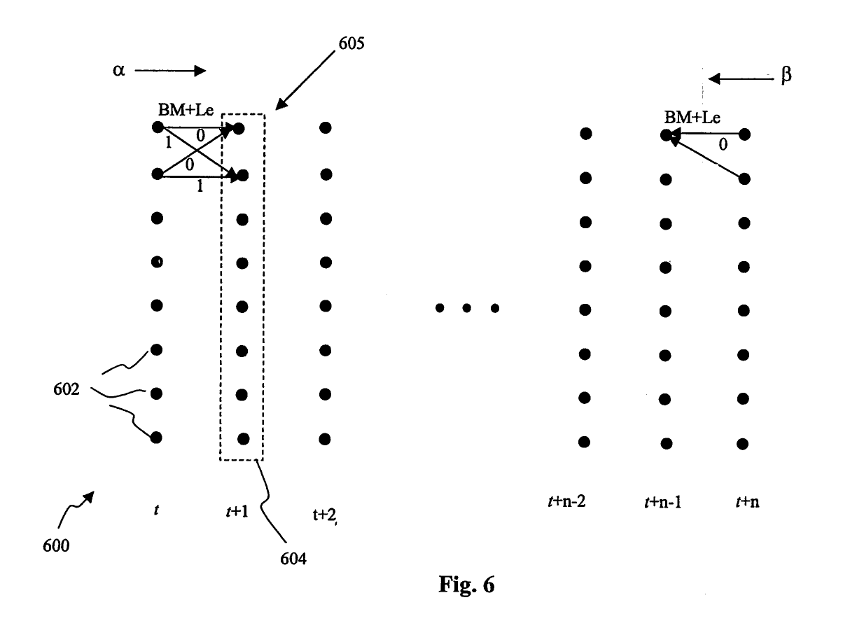

As a consequence, and now with reference to FIG. 6, in determining the α values during a forward recursion of the trellis 600 having path metric values 602 where the clamp is asserted by a setting of a corresponding one of the flags in the memory 518, the α values at a particular instance in time (t+1, t+2, etc) for all states in the trellis 600 (e.g., a column 604 as illustrated) need not be stored in the α memory 508. The α values however are still used to enable calculation of corresponding α values at the next time instance (the next adjacent column 605 in the trellis 600).

Once the trellis has been traversed for the calculation of the α values, a reverse traversal is then performed to calculate the corresponding β values. Upon determination of each β value, the output 510 of the butterfly processors 502 is enabled. This enablement requires access to the α memory 506 to retrieve the corresponding α values from the memory for the corresponding time instance. A specific advantage of the present arrangement is that where the corresponding flag in the memory 518 is set, the butterfly processor 502 has knowledge that there are no retained α values for that time instance and thus the normally required access to the memory 506 need not be performed. Thus, a power saving in memory access is obtained, together with no increase in processing time.

Turning now to FIG. 7, which represents the loglikelihood calculator 504 of FIG. 5, the α, β and branch metric values 510 are provided to the loglikelihood calculator 504 such that the branch metric values are input via respective transparent latches 701 and 709 to corresponding loglikelihood ratio processors 710 and 712 for determining the likelihood of the decoded bit being a 0 or a 1. The corresponding α and β values are each provided to an array of transparent latches 702, 704, 706 and 708, the outputs of which are provided to the loglikelihood ratio processors 710 and 712. Each of the latches 701, 702, 704, 706, 708 and 709 is supplied by a common enable signal which is the state of the corresponding flag in the memory 518 for that time instance, this being one of the values previously determined by the comparator 516. In FIG. 7, this state is identified by the reference numeral 740.

The respective outputs 714 and 716 of each of the loglikelihood processors 710 and 712 are then provided to a subtractor 718 to determine the loglikelihood ratio 720. The a priori data 117,109 is presented to each of a latch. 732 and a multiplexer 730. The latch 732 receives the enable signal 740 to present the a priori data 117,109 to a second subtractor 722. The subtractor 722 receives the loglikelihood ratio 720 and the a priori data 117,109 to produce an extrinsic output value 724. In practical implementations, the output value 724 is typically an 11-bit number, corresponding to the aforementioned damp value of 512, which is provided to a clamping and quantizing unit 726. The unit 726 performs a clamping function as described in FIG. 3(a) and companding function such as that described with reference to FIG. 3(b) or FIG. 4 to produce a quantized output 728. The quantized output 728 in the practical implementation is advantageously a 5-bit value, which is input to a multiplexer 730 that selects either the new quantized 728 value or the a priori input 117,109. The multiplexer 730 is enabled by the signal 740 described above. The output of the multiplexer 730 is the current extrinsic value 107,112 output from the decoder 106,111.

In cases where the (de)interleavers 114 and 108 are implemented by a single reconfigurable memory, there is no requirement to write the new is extrinsic value 107, 112 to memory, as such will correspond to that (e.g., 117, 109) which was previously obtained from memory. The transparent latches 701, 702, 704, 706, 708, 709 and 732 hold the α, β and branch metric values 510 and a priori input 117, 109 until the enable signal 740 is activated, at which time the values are presented to the loglikelihood processors 710, 712 and the subtractor 722, as described above. The functionality of the latches may alternatively be implemented using AND gates. AND gates toggle to a zero state, which may be advantageous during long periods of inactivity. AND gates also provide a more simple structure. A disadvantage of using AND gates is that AND gates have to toggle to the zero state and back up to an enabled state, which may be less efficient than latches during periods of high activity.

The principles of the method described herein have general applicability to decoding in telecommunications systems.

It is apparent from the above that the arrangements described are applicable to decoding in telecommunications systems.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as a wireless unit, a base station, a base station controller, a mobile switching center and/or a radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method comprising:
identifying a priori data input for at least one time slice of a plurality in a trellis; and
removing the one time slice from an extrinsic determination.

2. The method according to claim 1, wherein the a priori data input is identified relative to a threshold value, the threshold value being substituted for an output extrinsic of the extrinsic determination for the one time slice.

3. The method according to claim 2, wherein a flooring function is applied to the output extrinsic for each time slice.

4. The method according to claim 2, wherein a quantizing process is applied to the output extrinsic for each time slice if the a priori input data to the extrinsic determination is less than the threshold value.

5. The method according to claim 2, wherein a flag is set for each time slice to disable a storage of metric values associated with the corresponding time slice.

6. The method according to claim 5, wherein a loglikelihood ratio determination of the extrinsic determination is annulled if the flag is set for the corresponding time slice.

7. The method according to claim 1, further comprising the step of iterative soft input-soft output iterative decoding in which loglikelihood ratio and output extrinsic determinations are performed.

8. The method according to claim 7, wherein the iterative soft input-soft output iterative decoding is LogMAP iterative decoding.

9. The method of claim 1, wherein the step of identifying a priori data input comprises
identifying instances of input extrinsic data that are greater than or equal to a threshold.

10. The method of claim 9, further comprising:
substituting the threshold for each identified instance of input extrinsic data.

11. The method according to claim 10, wherein the step of identifying instances of input extrinsic data comprises:
utilizing the threshold in place of the identified instances of extrinsic data in at least one subsequent iteration of the iterative decoding.

12. A method of iterative decoding comprising:
determining an absolute value of an instance of extrinsic data;
assigning a quantized value of 0 to the instance of extrinsic data if the absolute value of the instance of extrinsic data is less than 1; and
assigning a quantized value to the instance of the extrinsic data if the absolute value of the instance of the output extrinsic is greater than or equal to 1, the quantized value retailing the sign of the instance of extrinsic data and having a magnitude of about 2^{x}, where x is the largest integer from a range [0,y] such that 2^{x} is the largest integer less than or equal to the absolute value of the instance of extrinsic data.

13. The method according to claim 12, further comprising:
substituting the quantized value for each instance of the extrinsic data for the one time slice.

14. The method according to claim 13, wherein y is equal to 9.

15. A decoder comprising:
a processing unit; and
means for identifying a priori data input for at least one time slice of a plurality in a trellis in response to output extrinsic determination, the means for identifying setting a flag for each time slice.

16. The decoder of claim 15, wherein the means for identifying compares the a priori data input with a threshold value for each time slice, and sets the flag if the a priori data input equals or exceeds the threshold value.

17. The decoder of claim 16, further comprising:
means for disabling a storage of metric values associated with the time slice and for disabling a computation of a loglikelihood ratio corresponding to the time slice in response to the flag for a corresponding time slice.

18. The decode of claim 16, wherein the decoder is applied to LogMAP iterative decoding.

19. A decoder comprising:
a processing unit for calculating a trellis using systematic data, parity data and a priori data, and for storing alpha values in an alpha memory determined during a forward recursion; and
a comparator for comparing each instance of the a priori data for a time slice against a threshold value, and for producing a flag corresponding to at least one entry in the alpha memory if the instance of the a priori data is greater than or equal to the threshold value.

20. The decoder of claim 19, further comprising:
a calculator for producing extrinsic values from the stored alpha values, beta values determined during a backward recursion, branch metric values and the a priori data, wherein the comparator substitutes the threshold value with the corresponding alpha value to produce the extrinsic values.
